(19) United States
(12) Patent Application Publication
(10) Pub. No.: US 2024/0048508 A1
(43) Pub. Date: Feb. 8, 2024

(54) Mixed-Dimension Order Routing

(71) Applicant: Marvell Asia Pte Ltd, Singapore (SG)

(72) Inventors: Anthony Viego, Cambridge, MA (US); Joseph Featherston, Brookline, MA (US); Aadeetya Shreedhar, Natick, MA (US)

(21) Appl. No.: 18/154,314

(22) Filed: Jan. 13, 2023

Related U.S. Application Data
(60) Provisional application No. 63/395,955, filed on Aug. 8, 2022.

(51) Int. Cl. H04L 49/109; H04L 47/122; H04L 45/58; H04L 49/25

(52) U.S. Cl. CPC H04L 49/109; H04L 47/122; H04L 45/583; H04L 49/25

(57) ABSTRACT

A circuit and corresponding method employ mixed-dimension order routing. The circuit comprises an interconnect, associated with a two-dimensional (2D) coordinate system, and a switch coupled to the interconnect. The switch determines a route path for a flit based on a mixed-dimension order routing method. The flit originates at an origin. The mixed-dimension order routing method employs, based on the origin of the flit, vertical-to-horizontal dimension routing or horizontal-to-vertical dimension routing. The switch routes the flit via the interconnect of the circuit based on the route path determined. The vertical-to-horizontal dimension routing and horizontal-to-vertical dimension routing are relative to the 2D coordinate system. The mixed-dimension order routing method prevents deadlock and congestion that otherwise degrade performance of the circuit.

### RELATED APPLICATION

This application claims the benefit of U.S. Provisional Application No. 63/395,955, filed on Aug. 8, 2022. The entire teachings of the above application are incorporated herein by reference.

### BACKGROUND

Multi-core chips enable parallel computing and other functionality within computing devices, such as personal computers, servers, mobile devices, etc., for non-limiting examples. A multi-core chip may include a network of nodes, referred to interchangeably herein as tiles, and each node may include its own processor, local memory, and other supportive device(s) for non-limiting example. The nodes may communicate via messages. The network may connect each node directly to only a few other nodes, referred to as neighbors. The nodes may be interconnected on the multi-core chip via an on-chip interconnect of routing channels, such as wire conductors or other transmission media.

A topology of the network may define which nodes are neighbors and a node may communicate to a non-neighboring node through one of its neighbors. A routing method may be implemented at a node to determine a route path for routing a message. The route path may include turns along the interconnect. In a network topology that employs a two-dimensional (2D) interconnect, a turn may include a ninety-degree change in a traveling direction of the message.

In a 2D interconnect, turns may include an East-South (ES) turn, that is, a turn which involves a change in direction from East to South, as well as South-West (SWE), West-North (WN), North-West (NW), West-South (WS), South-East (SE), East-North (EN), and North-East (NE) turns. The turns may be classified into clockwise (CW) turns, i.e., NE, ES, SWE, and WN turns, and counter-clockwise (CCW, anti-clockwise) turns, i.e., NW, WS, SE, and EN turns.

### SUMMARY

According to an example embodiment, a method comprises determining a route path for a flit within a chip based on a mixed-dimension order routing method. The flit originates at an origin. The mixed-dimension order routing method employs, based on the origin of the flit, vertical-to-horizontal dimension routing or horizontal-to-vertical dimension routing. The method further comprises routing the flit via an interconnect of the chip based on the route path determined. The interconnect is associated with a two-dimensional (2D) coordinate system. The vertical-to-horizontal dimension routing and horizontal-to-vertical dimension routing are relative to the 2D coordinate system.

The flit may be a portion of a packet or the packet in its entirety.

The 2D coordinate system may include an x-axis and a y-axis. The vertical-to-horizontal dimension routing may include turning from a vertical direction to a horizontal direction. The horizontal-to-vertical dimension routing may include turning from the horizontal direction to the vertical direction. The horizontal direction and vertical direction may be parallel to the x-axis and y-axis, respectively.

The interconnect may form a 2D mesh structure of a plurality of nodes (also referred to interchangeably herein as “tiles”). A node of the plurality of nodes may include a switch. The routing may include transmitting, via the switch, the flit to another node of the plurality of nodes. The switch may be referred to interchangeably herein as a SW or a mesh switch (MSW) of a tile/node.

The mixed-dimension order routing method may include employing the horizontal-to-vertical dimension routing in an event the origin is a device located at an edge of the interconnect of the chip, and employing the vertical-to-horizontal dimension routing otherwise.

Positive y-coordinates and positive x-coordinates of the 2D coordinate system may be associated with rows and columns of the interconnect, respectively. The positive x-coordinates may increase in an east direction of the interconnect. The edge may be a right edge of the interconnect. The right edge may be located in the east direction.

The method may further comprise avoiding routing deadlock by employing the mixed-dimension order routing method. The routing deadlock may otherwise prevent transmission of the flit via the interconnect.

The method may further comprise reducing congestion in the interconnect by employing the mixed-dimension order routing method. The congestion may be reduced relative to employing a different routing method that employs the horizontal-to-vertical dimension routing, exclusively, or the vertical-to-horizontal routing, exclusively.

The interconnect may include a top row, bottom row, and a plurality of columns. The reducing may include reducing the congestion in the top row, the bottom row, a column of the plurality of columns, or a combination thereof. The congestion in the top row, bottom row, or column may be due to traffic received from a respective edge device coupled to the top row, bottom row, or column. The respective edge device may be external to the interconnect.

The mixed-dimension order routing method may include prohibiting, at most, a first turn type and a second turn type. The first turn type and second turn type may be from a plurality of clockwise turn types and a plurality of counter-clockwise turn types, respectively.

The positive y-coordinates may decrease in a north direction. The positive x-coordinates may increase in an east direction. The mixed-dimension order routing method may include prohibiting the flit from traversing the interconnect in the east direction and turning to traverse the interconnect in the north direction.

A top row of the interconnect may be associated with the north direction. The prohibiting may include an exception. The exception may enable the flit, traversing the interconnect in the east direction, to turn to traverse the interconnect in the north direction, in an event the flit is heading in the east direction along the top row and turning in the north direction to a traffic sink.

The positive y-coordinates may increase in a south direction. The mixed-dimension order routing method may include prohibiting the flit from traversing the interconnect in the east direction and turning to traverse the interconnect in the south direction.

A bottom row of the interconnect may be associated with the south direction. The prohibiting may include an exception. The exception may enable the flit, traversing the interconnect in the east direction, to turn to traverse the interconnect in the south direction, in an event the flit is heading in the east direction along the bottom row and turning in the south direction to a traffic sink.

According to another example embodiment, a circuit comprises an interconnect, associated with a two-dimensional (2D) coordinate system, and a switch coupled to the interconnect. The switch is configured to determine a route path for a flit based on a mixed- dimension order routing method. The flit originates at an origin. The mixed-dimension order routing method employs, based on the origin of the flit, vertical-to-horizontal dimension routing or horizontal-to-vertical dimension routing. The switch is further configured to route the flit via the interconnect of the circuit based on the route path determined. The vertical-to-horizontal dimension routing and horizontal-to-vertical dimension routing are relative to the 2D coordinate system.

Further alternative circuit embodiments parallel those described above in connection with the example method embodiment.

According to another example embodiment, an apparatus comprises means for determining a route path for a flit within a chip based on a mixed-dimension order routing method. The flit originates at an origin. The mixed-dimension order routing method employs, based on the origin of the flit, vertical-to-horizontal dimension routing or horizontal-to-vertical dimension routing. The apparatus further comprises means for routing the flit via an interconnect of the chip based on the route path determined. The interconnect is associated with a two-dimensional (2D) coordinate system. The vertical-to-horizontal dimension routing and horizontal-to-vertical dimension routing are relative to the 2D coordinate system.

Further alternative apparatus embodiments parallel those described above in connection with the example method embodiment.

It should be understood that example embodiments disclosed herein can be implemented in the form of a method, apparatus, system, or computer readable medium with program codes embodied thereon.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a user interacting with a mobile device that includes an example embodiment of a circuit disclosed herein.

FIG. 2A is a block diagram of an example embodiment of a circuit that employs an example embodiment of mixed-dimension order routing.

FIG. 2B is a block diagram of an example embodiment of a 2D mesh structure with a plurality of nodes arranged in a network topology.

FIG. 2C is a block diagram of an example embodiment of a node.

FIG. 2D is a block diagram of an example embodiment of a flit.

FIG. 2E is a block diagram of an example embodiment of a layout of a circuit.

FIG. 2F is a block diagram of an example embodiment of restricted turn types.

FIG. 3 is a flow diagram of an example embodiment of a method that employs an example embodiment of mixed-dimension order routing.

FIG. 4A is a flow diagram of another example embodiment of a method that employs an example embodiment of mixed-dimension order routing.

FIG. 4B is a continuation of the flow diagram of FIG. 4A.

FIG. 5A is a schematic diagram of an example embodiment of a layout of a circuit with an exemplification of congestion in a rightmost column of an interconnect of the circuit.

FIG. 5B is a schematic diagram of an example embodiment of the layout of FIG. 5A with an exemplification of congestion in a top row and bottom row of the interconnect.

FIG. 5C is an exemplification of horizontal-to-vertical routing metrics within the layout FIGS. 5A-B

FIG. 5D is an exemplification of vertical-to-horizontal routing metrics within the layout of FIGS. 5A-B

FIG. 5E is an exemplification of mixed-dimension routing metrics within the layout of FIGS. 5A-B.

### DETAILED DESCRIPTION

A description of example embodiments follows.

A flow control unit (flit), as referred to herein, refers to a packet (message) or portion of the packet. The packet may represent a command or response for non-limiting examples. While an example embodiment disclosed herein may be described as being implemented on a mobile device, it should be understood that an example embodiment disclosed herein is not limited to being implemented on the mobile device.

Central processor units (CPUs), also referred to interchangeably herein as application processors (APs), processors, processor cores, or cores, often need to send flits to other blocks in a multi-core system. Such other blocks may be other APs, last-level cache (LLC) slices, also referred to interchangeably herein as Tag and Data (TAD) devices, or memory controllers. Such flits may be sent between the blocks through an interconnect fabric that may be referred to interchangeably herein as an interconnect, mesh interconnect, or mesh. The interconnect may form a two-dimensional (2D) mesh structure that includes a plurality of nodes, also referred to interchangeably herein as “tiles,” and each node may include a switch, also referred to interchangeably herein as a mesh switch (MSW), which allows flits to be passed from one node to another. Each switch may be coupled to neighboring node switches that may be located in cardinal directions (e.g., four connections) in the 2D mesh structure. Coupling between nodes may be performed via a routing channel (RC) that may also be referred to interchangeably herein as a link. Each switch may be further coupled to local devices, such as an AP and TAD of the node.

In a 2D mesh, routing deadlock has the potential to occur when a circular waiting loop of flits is formed. The waiting loop occurs when a series of flits across four or more nodes are each dependent on flits in the loop being transmitted in order to be transmitted themselves. When this dependency forms a loop, deadlock will occur. To avoid this issue, a routing method may be employed to prevent such a loop from forming. In a 2D mesh, there are two loops to consider, a clockwise loop (CW) and a counter-clockwise (CCW, anti-clockwise) loop. Each loop includes four “turns.” For example, a flit heading east that is then sent north would be one turn in a CCW loop. By eliminating a set of turns from each loop, neither a CW loop nor CCW loop can be formed since all turns of such loops are not available and, thus, the waiting loop described above cannot be formed and deadlock can be prevented.

Dimension order routing is a method which makes use of this idea by only allowing flits to be routed in one direction and then the other, such as vertically and then horizontally. This eliminates two turns from each loop, preventing deadlock. A generic dimension order routing method can, however, have negative effects on mesh congestion. Hot-spots (regions of congestion) may be created when mesh traffic results in large amounts of flits being routed in a single row or column of the interconnect.

For example, flits received from memory controllers external to the interconnect for transmission to TADs may all traverse a top row and bottom row of the interconnect in an exclusive horizontal-to-vertical routing method, while flits being transmitted from other external devices, such as input/output blocks (IOBs) for non-limiting example, may all need to traverse a rightmost column of the interconnect in an exclusive vertical-to-horizontal routing method. As such, exclusive use of either of such types of dimension order routing would result in bottlenecks with an area of high mesh congestion and, thus, degrade mesh performance.

Other solutions to avoid deadlock are to use virtual channels or real-time deadlock detection mechanisms. Such solutions, however, can be expensive in terms of area and power consumption. An example embodiment disclosed herein employs a new routing method referred to herein as mixed-order dimension routing, or MIDOR. With mixed-order dimension routing, flits can be routed in both a vertical-to-horizontal manner and, partially, in a horizontal-to-vertical manner, while being deadlock avoidant by construction. The horizontal-to-vertical manner may be used, partially, since horizontal-to-vertical routing may only be allowed in the case where the flit originates in the right edge of the mesh according to a non-limiting example embodiment.

An example embodiment of the mixed-order dimension routing method ensures deadlock is prevented as there are two turns being prohibited, one in the CCW loop and one in the CW loop. Specifically, routing in which a flit is heading east and then turns north or south may be prohibited. An exception to such restriction may, however, be employed, that is, when a flit is heading east along the top row of the mesh and turns north to a traffic-sink, or when a flit is heading east along the bottom row and turns south to a traffic-sink. Since these flits are leaving the mesh and can no longer contribute to routing deadlock, such turns may be deemed acceptable.

An advantage of an example embodiment of a mixed-dimension order routing method disclosed herein is that such embodiment prevents deadlock by construction and, simultaneously, reduces mesh congestion by allowing flits to be routed in a manner more suitable to the traffic patterns of their sources. An example embodiment of a mixed-dimension order routing method disclosed herein accomplishes this without the logical complexity of a real-time deadlock identification system, and without the area and power overhead of virtual channels.

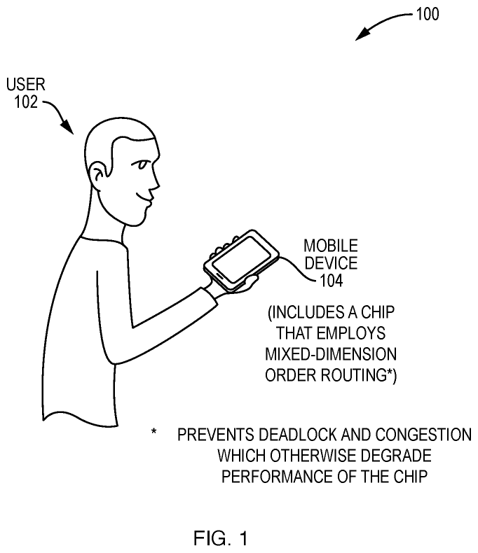

Traffic originating from an edge device, at an edge of the interconnect, such as an input/output bridge (IOB) for non-limiting example, may be routed horizontally first and then vertically, preventing mesh congestion in the rightmost column of the mesh by eliminating the need for flits to be routed along that column first before then being routed to their destination. Likewise, traffic coming from memory controllers is typically sent to the various TADs throughout the mesh. By routing such traffic vertically and then horizontally, the need for flits to be routed along the top and bottom rows first, before then being sent to the destination TADs, may be eliminated, thereby preventing congestion in these areas. A device that may employ such mixed-order dimension routing on a chip is disclosed below with reference to FIG. 1 for non-limiting example.

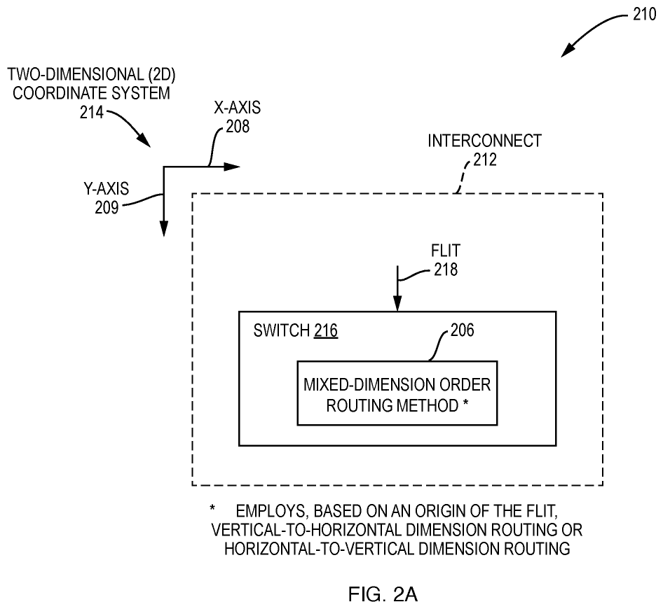

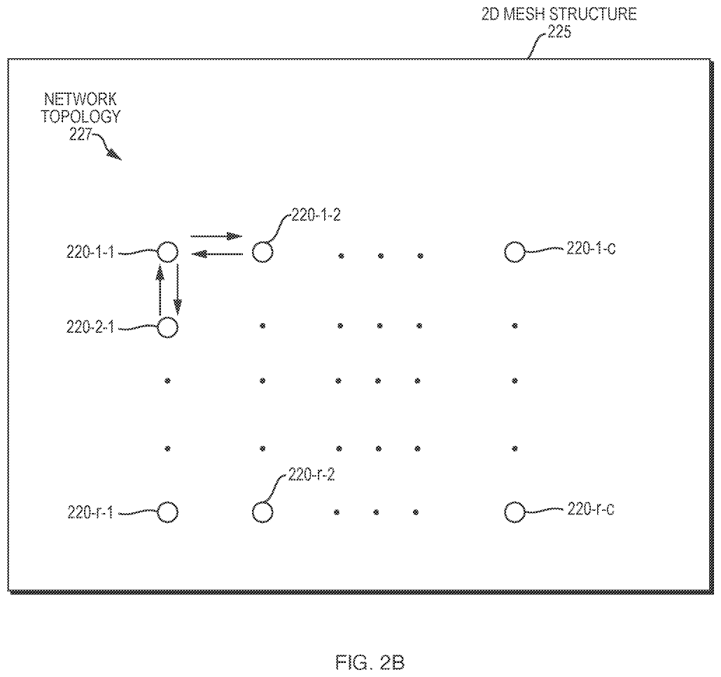

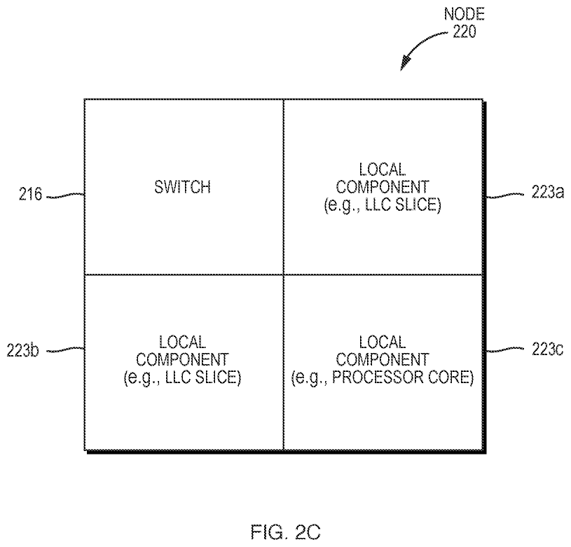

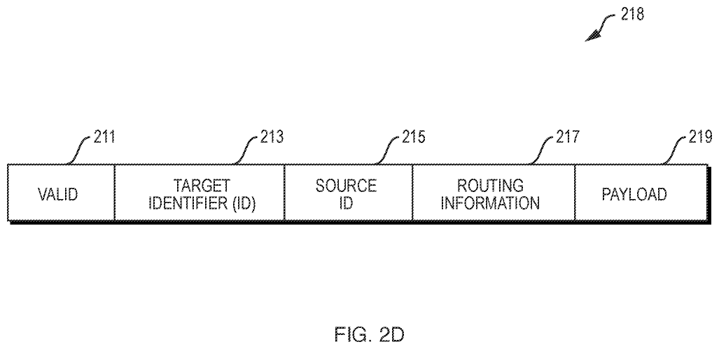

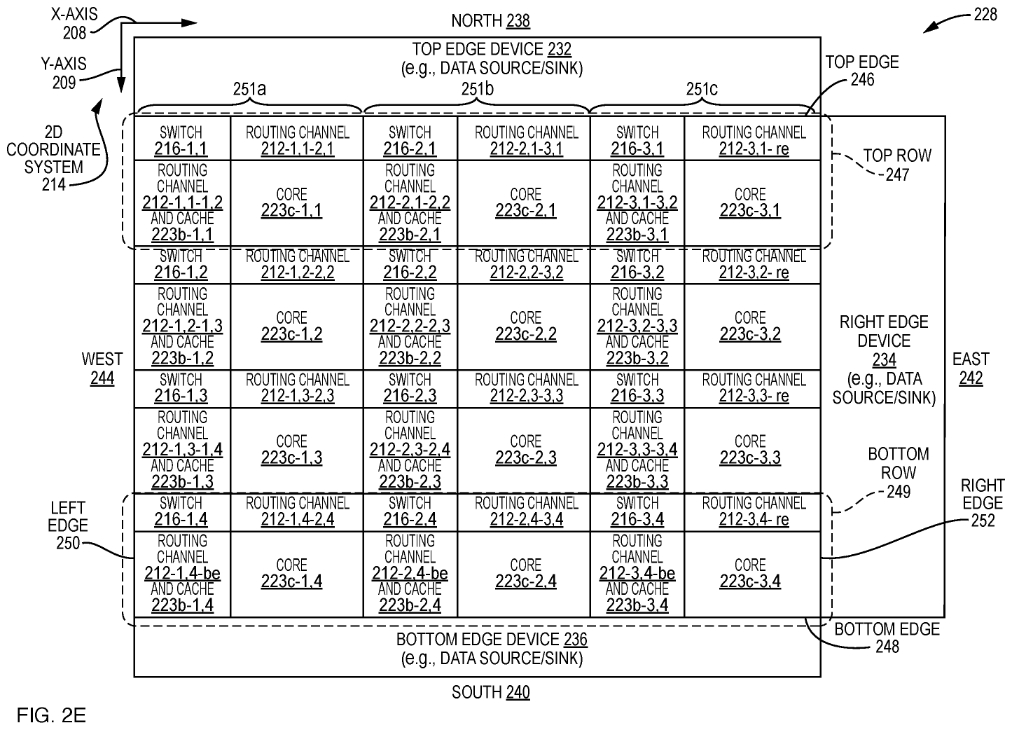

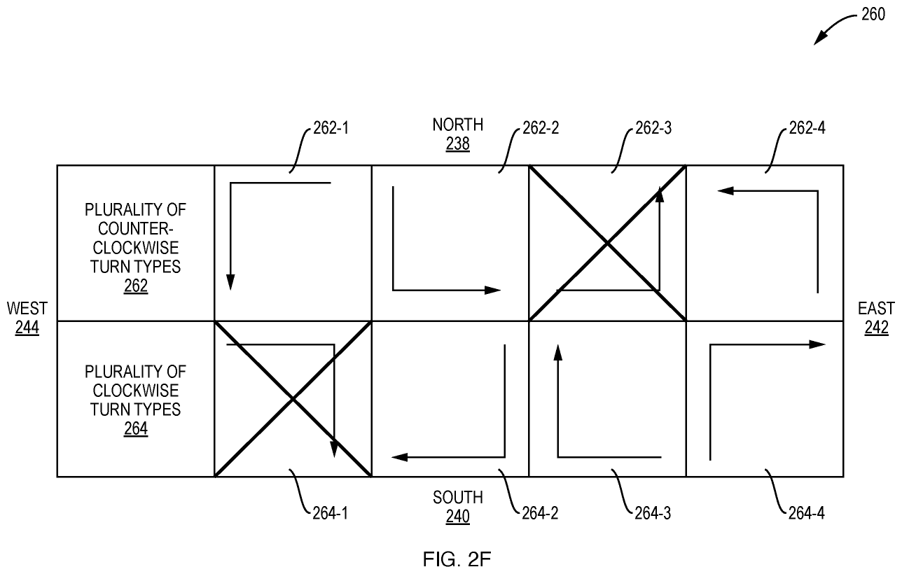

FIG. 1 is a block diagram 100 of a user 102 interacting with a mobile device 104 that may employ an example embodiment disclosed herein. According to an example embodiment, the mobile device 104 may include a chip (not shown) that employs an example embodiment of a mixed-dimension order routing method disclosed herein. An example embodiment of the mixed- dimension order routing method may prevent deadlock and congestion which otherwise degrades performance of the chip. The chip may comprise a circuit with a switch that determines a route path for a flit based on an example embodiment of the mixed-dimension order routing method, as disclosed below with regard to FIG. 2A.

FIG. 2A is a block diagram of an example embodiment of a circuit 210. The circuit 210 comprises an interconnect 212 associated with a two-dimensional (2D) coordinate system 214. The circuit 210 may further comprise a switch 216 coupled to the interconnect 212. The switch 216 may be configured to determine a route path (not shown) for a flit 218 based on a mixed-dimension order routing method 206. The flit 218 may originate at an origin (not shown). The mixed-dimension order routing method 206 may employ, based on the origin of the flit 218, vertical-to-horizontal dimension routing (not shown) or horizontal-to-vertical dimension routing (not shown). The switch 216 may be further configured to route the flit 218 via the interconnect 212 of the circuit 210 based on the route path determined. The vertical-to-horizontal dimension routing and horizontal-to-vertical dimension routing may be relative to the 2D coordinate system 214. The switch 216 may be further configured to avoid routing deadlock by employing the mixed-dimension order routing method 206. The routing deadlock may otherwise prevent transmission of the flit 218 via the interconnect 212. To employ the mixed-dimension order routing method 206, the switch 216 may be configured to perform the mixed-dimension order routing method 206. For example, the circuit 210 may include a non-transitory computer-readable medium having encoded thereon a sequence of instructions which, when loaded and executed by the switch, causes the switch to perform the mixed-dimension order routing method 206.

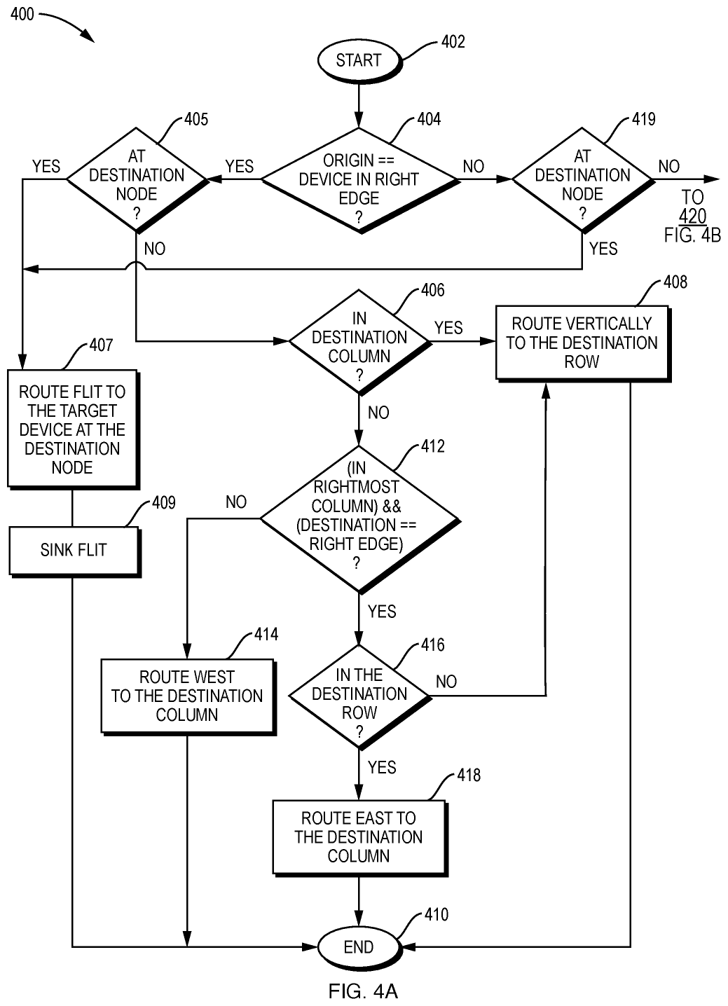

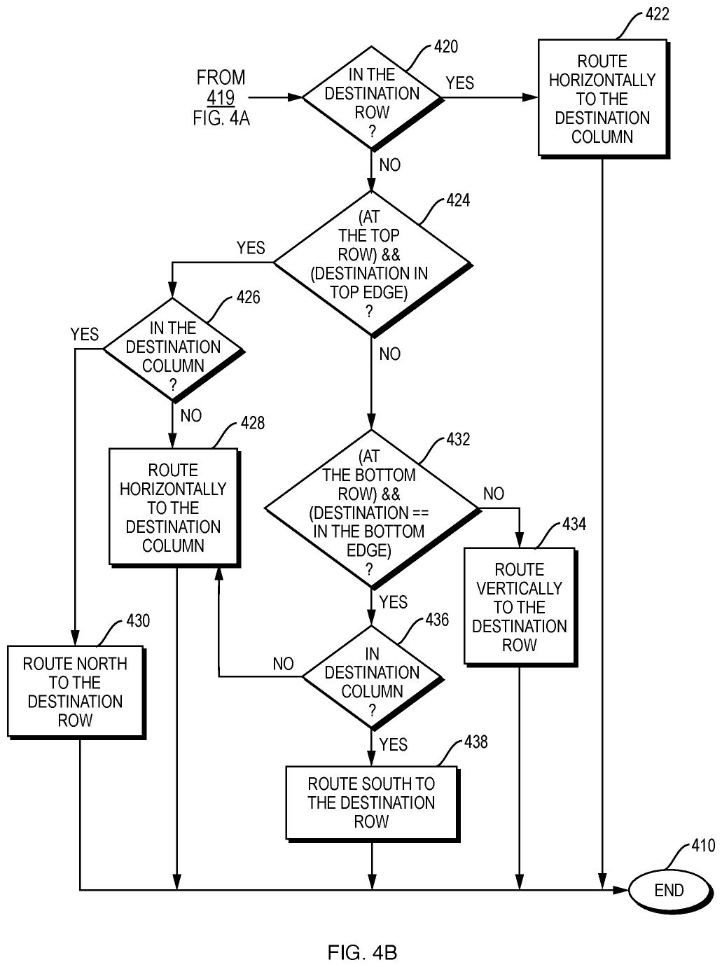

The mixed-dimension order routing method 206 may select, based on the origin of the flit 218, whether to employ the vertical-to-horizontal dimension routing or the horizontal-to-vertical dimension routing, as disclosed further below with regard to FIG. 4A and FIG. 4B. Continuing with reference to FIG. 2A, the flit 218 may be a portion of a packet (not shown) or the packet in its entirety.

The 2D coordinate system 214 may include an x-axis 208 and a y-axis 209. The vertical-to-horizontal dimension routing may include turning from a vertical direction (not shown) to a horizontal direction (not shown). The horizontal-to-vertical dimension routing may include turning from the horizontal direction to the vertical direction. The horizontal direction and vertical direction may be parallel to the x-axis 208 and y-axis 209, respectively. The interconnect 212 may form a 2D mesh structure of a plurality of nodes, such as disclosed below with regard to FIG. 2B.

FIG. 2B is a block diagram of an example embodiment of a 2D mesh structure 225 with a plurality of nodes (220-1-1, . . . 2202-r-c) arranged in a network topology 227 for non-limiting example. With reference to FIGS. 2A and 2B, in the network topology 227, the interconnect 212 for coupling such nodes is not shown and neighboring nodes (NBNs) are nodes that are adjacent to other nodes for non-limiting example. For example, the node 220-1-1 is a neighboring node (NBN) to the node 220-1-2 and vice versus and the node 220-1-1 is a NBN to the node 220-2-1 and vice-versus. A node of the plurality of nodes (220-1-1, . . . 2202-r-c) may include the switch 216. An example embodiment of such a node is disclosed below with regard to FIG. 2C.

FIG. 2C is a block diagram of an example embodiment of a node 220. With reference to FIGS. 2A, 2B, and 2C, in addition to the switch 216, the node 220 includes a first local component 223a, a second local component 223b, and a third local component 223c. It should be understood that the node 220 is not limited to three local components. The first local component 223a, second local component 223b, and third local component 223c may be a first last-level cache (LLC) slice of an LLC (not shown) of the node 220, a second LLC slice of the LLC, and a processor core of the node 220, respectively, for non-limiting examples. The processor core may be referred to interchangeably herein as an application processor (AP) or central-processing unit (CPU). The LLC slice may also be referred to interchangeably herein as a TAD. CPUs (APs) in a multi-core system often need to send flits to other blocks in the system, such as other APs, last-level cache slices (TADs), or memory controllers.

Such local components may be sources for creating flits to be transmitted from the node 220 or sink devices that may serve as a final destination for a flit, such as the flit 218. The switch 216 enables flit communications with the local components (223a, 223b, 223c) via respective local switch-RX ports (not shown) and respective local switch-TX ports (not shown) of a plurality of local switch-RX ports (not shown) and a plurality of local switch-TX ports (not shown), respectively, such as disclosed in U.S. patent application Ser. No. 17/934,017, entitled “Directional Link Credit-Based Packet Transmission” and filed on Sep. 21, 2022 (the “'017 Patent Application”), the entire teachings of which are incorporated herein by reference.

The switch 216 may be further configured to route the flit 218 by transmitting the flit 218 to another node of the plurality of nodes (220-1-1, . . . 2202-r-c). In the network topology 227, the plurality of nodes (220-1-1, . . . 2202-r-c) are arranged in columns (e.g., 1, . . . , c) and rows (e.g., 1, . . . , r), and such network topology may be based on a cartesian coordinate system in which such nodes are assigned x- and y- coordinates. Based on an origin of the flit 218, the mixed-dimension order routing method 206 may employ vertical-to-horizontal dimension order routing or horizontal-to-vertical dimension order routing. As such, based on an x-y coordinate pair of the flit 218, the mixed-dimension order routing method 206 may select between vertical-to-horizontal dimension order routing or horizontal-to-vertical dimension order routing in determining a route path for the flit 218. Such a route path may be employed by the switch 216 to determine, for non-limiting example, a next hop for the flit 218.

It should be understood that such next hop may not be an immediate next hop. For example, the switch 216 may receive the flit 218 with route information designated the immediate next hop. The switch 216 may employ the mixed-order dimension routing method to determine a further hop for the flit 218 to be taken at the immediate next hop (e.g., neighboring node), such as disclosed in the '017 Patent Application. The switch 216 may update routing information of the flit 218 to designate such next hop based on a route path (not shown) determined via the mixed-dimension order routing method 206. An example embodiment of the routing information is disclosed further below with regard to FIG. 2D for non-limiting example.

Continuing with reference to FIG. 2A, if vertical-to-horizontal dimension order routing is employed, that is, selected by the mixed-dimension order routing method 206 based on the origin of the flit 218, the flit 218 may be routed vertically from a source node represented via a source ID (e.g., x- y- coordinates) in the flit 218 until it reaches the row of the destination node (y coordinate matches) represented via a destination ID (e.g., x- y- coordinates) in the flit 218, at which point the flit 218 may then be routed horizontally to the correct column (x coordinate matches) in which the destination node resides. If horizontal-to-vertical dimension order routing is employed, the flit 218 may be routed horizontally from a source node represented via a source ID (e.g., x- y- coordinates) in the flit 218 until it reaches the column of the destination node (x coordinate matches) represented via a destination ID (e.g., x- y- coordinates) in the flit 218, at which point the flit 218 may then be routed vertically to the correct row (y coordinate matches) in which the destination node resides. Once at the destination node, the flit 218 may be output to a local TX switch port specified in a target ID of the flit 218, as disclosed below with regard to FIG. 2D.

FIG. 2D is a block diagram of a non-limiting example embodiment of the flit 218 of FIG. 2A, disclosed above. Continuing with reference to FIG. 2D, the flit 218 is split into fields, namely a valid field 211, a target ID field 213, a source ID field 215, a routing information field 217, and a payload field 219. The valid field 211 may be used to indicate whether the flit 218 is valid or not.

The flit 218 may include a target ID and a source ID stored in the target ID field 213 and source ID field 215, respectively. With reference to FIGS. 2A-D, the target ID in the target ID field 213 may represent a destination node of the plurality of nodes (220-1-1, . . . 2202-r-c) for the flit 218 or a destination edge device (not shown) at an edge of the interconnect 212. The source ID of the source ID field 307 may represent a source node of the plurality of nodes (220-1-1, . . . 2202-r-c) or a source edge device (not shown) at an edge of the interconnect 212 at which the flit 218 originated, initially.

The target ID represented in the target ID field 213 may further represent a local TX port (not shown) of the destination node coupled to a local component (e.g., 223a, 223b, or 223c) at which to sink the flit 218. The local TX port may be local to the destination node. The source ID may further represent a local RX port (not shown) coupled to a local component (e.g., 223a, 223b, or 223c) of the source node. The local RX port may be local to the source node and coupled to a local component of the source node. The local component may be local to the source node and an originator of the flit 218, initially.

The network topology 227 may be based on a cartesian coordinate system for non- limiting example. The target ID and source ID represented in the target ID field 213 and source ID field 215, respectively, may represent a destination (sink) node, destination (sink) edge device, source node, or source edge device via respective x- and y- coordinates associated with such elements in the cartesian coordinate system, for non-limiting examples. The flit 218 may further include a payload in the payload field 219. The payload may include data sent from the source node/edge device to the destination node/edge device. An edge device may be located at an edge of the interconnect 212, such as disclosed below with regard to FIG. 2E.

FIG. 2E is a block diagram of an example embodiment of a layout 228 of the circuit 210 of FIG. 2A for non-limiting example. With reference to FIG. 2A and FIG. 2E, the switch 216 may be a switch of a plurality of switches (216-1,1; 216-2,1; 216-3, 1; 216-1,2; 216-2, 2; 216-3,2; 216-1,3; 216-2,3; 216-3,3; 216-1,4; 216-2,4; 216-3,4) within the layout 228. Such switches are coupled to the interconnect 212 that includes a plurality of routing channels (212-1,1-2,1; 212-2,1-3,1; 212-3,1-re; 212-1,1-1,2; 212-2,1-2,2; 212-3,1-3,2; 212-1,2-2,2; 212-2,2-3,2; 212-3,2-re;212-1,2-1,3; 212-2,2-2,3; 212-3,2-3,3; 212-1,3-2,3; 212-2,3-3,3;212-3,3-re; 212-1,3-1,4; 212-2,3-2,4; 212-3,3-3,4; 212-1,4-2,4; 212-2-4-3,4; 212-3,4-re; 212-1,4-be; 212-2,4-be; 212-3,4-be). Each routing channel may be referred to interchangeably herein as a “RC.” The switches may be included in respective nodes that further include a respective cache (e.g., 223b-1,1; 223b-2,1; 223b-3,1; 223b1,2; 223b-2,2;223b-3,2; 223b-1,3; 223b-2,3; 223b-3,3; 223b-1,4; 223b-2,4; 223b-3,4) and processor core (e.g., 223c-1,1; 223c-2,1; 223c-3,1; 223c-1,2; 223c-2,2; 223c-3,2; 223c-1,3; 223c-2,3; 223c-3,3; 223c-1-4; 223c-2,4; 223c-3,4), such as disclosed above with regard to FIG. 2C.

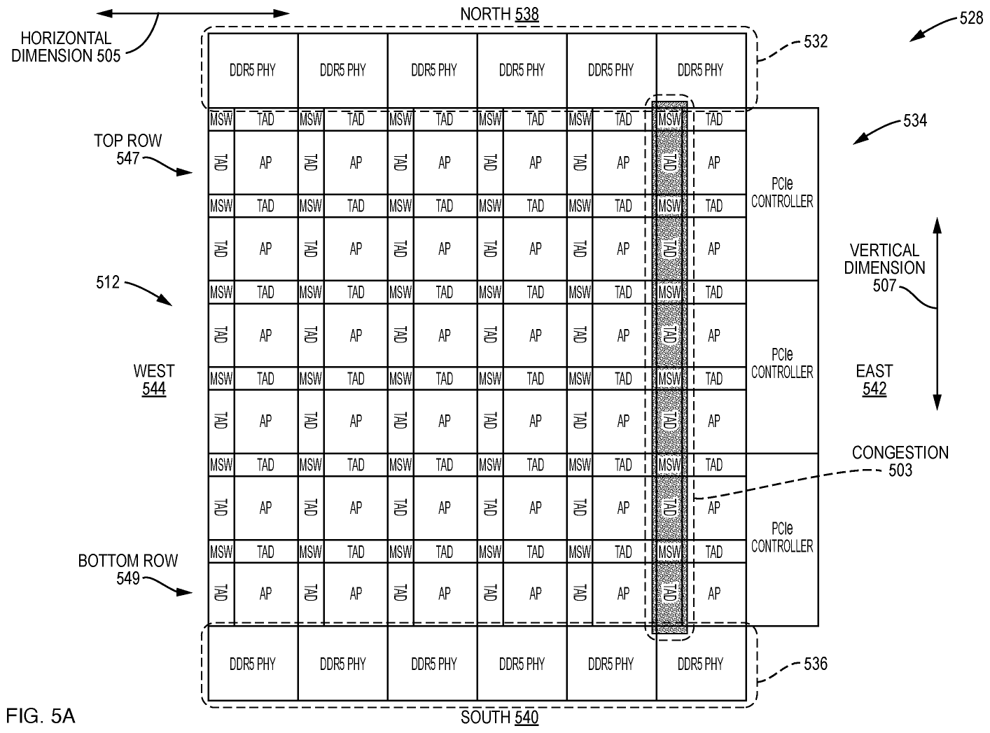

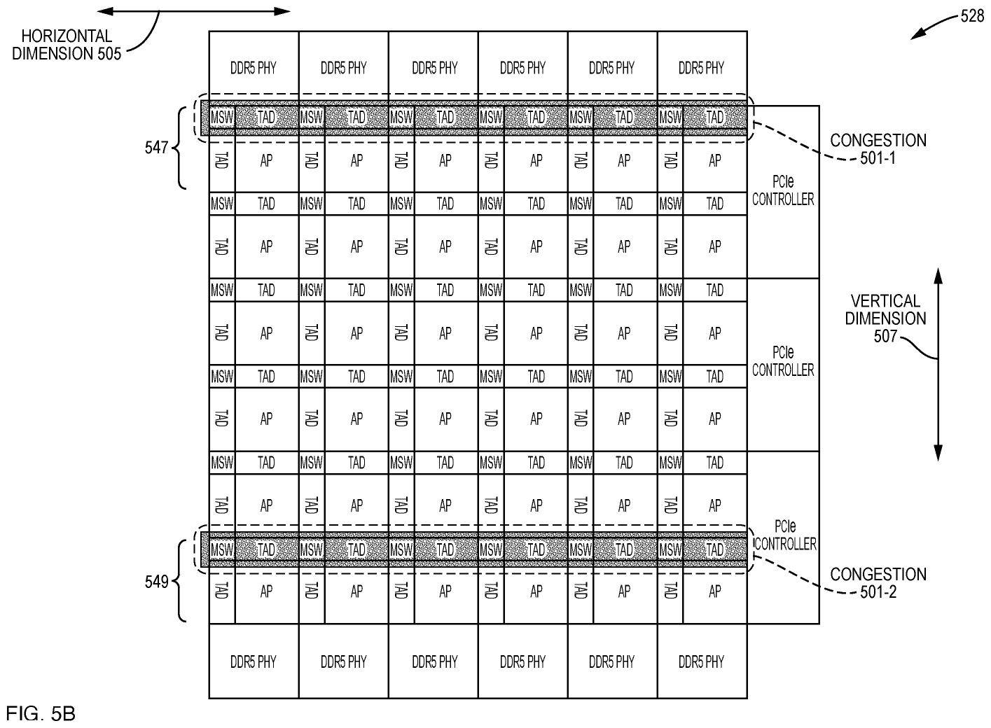

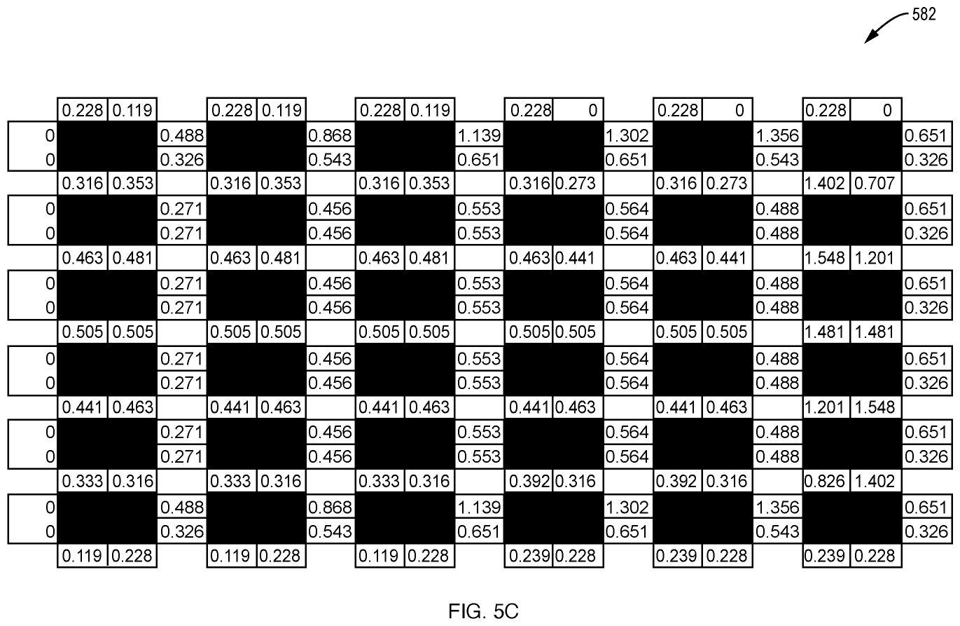

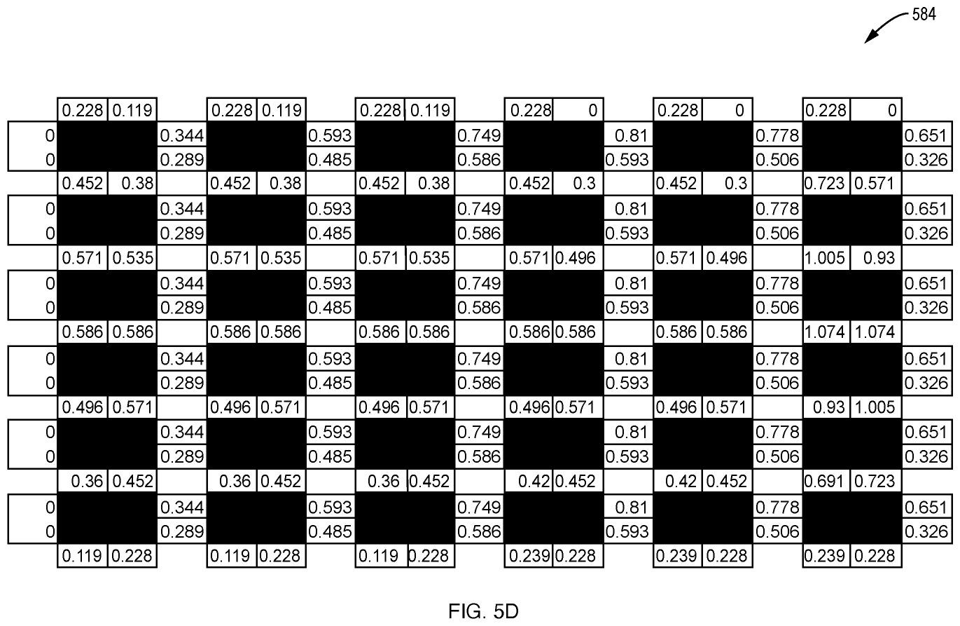

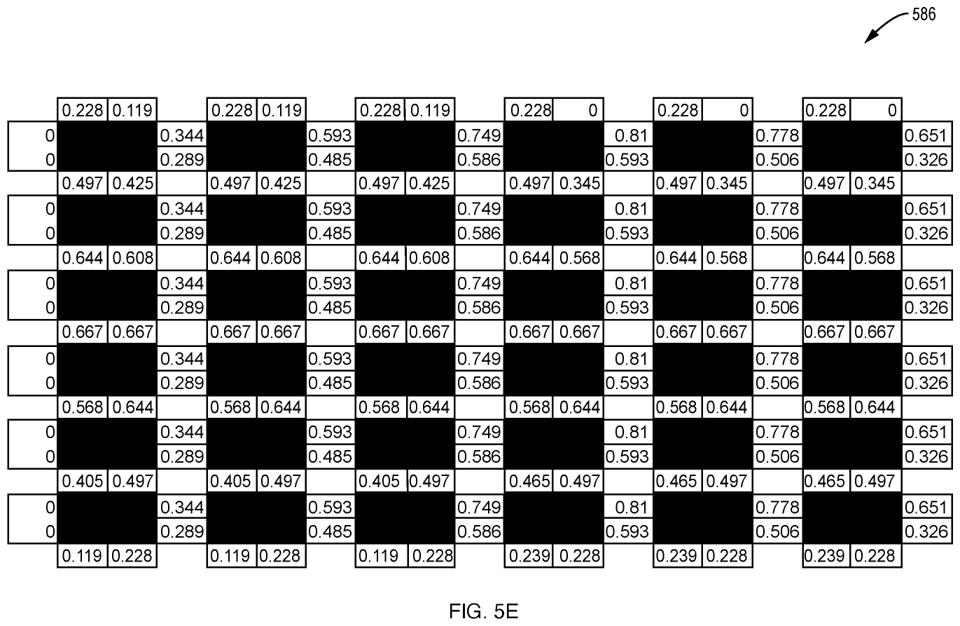

Continuing with reference to FIG. 2A and FIG. 2E. the interconnect 212 may be associated with north 238, south 240, east 242, and west 244 directions. A top edge 246, right edge 252, and bottom edge 248 of the interconnect 212 may be associated with the north 238, east 242, and south 240 directions, respectively. A top edge device 232, bottom edge device 236, and right edge device 234 may be at the top edge 246, bottom edge 248, and right edge 252 of the interconnect 212, respectively. Such edge devices may serve as a source or sink for flits. It should be understood that the top edge device 232, bottom edge device 236, and right edge device 234 may include a plurality of devices, such as disclosed further below with regard to FIG. 5A and 5B. For example, the top edge device 232 and bottom edge device 236 may include respective edge devices that source/sink flits on a per-column basis and the right edge device 234 may source/sink flits on a per-row basis.

Continuing with reference to FIG. 2A and FIG. 2E, according to an example embodiment, at least one edge of the interconnect 212 does not bring in traffic (flits) and is not coupled to an edge device. In the non-limiting example embodiment of FIG. 2E, such an edge is the left edge 250 of the interconnect 212 and is in the west 244 direction.

According to an example embodiment, the mixed-dimension order routing method 206 may include employing the horizontal-to-vertical dimension routing in an event an origin of the flit 218 is a device located at a particular edge of the interconnect 212 of the chip, and employing the vertical-to-horizontal dimension routing otherwise. The positive y-coordinates and positive x-coordinates of the 2D coordinate system 214 may be associated with rows and columns of the interconnect 212, respectively. The positive x-coordinates may increase in the east 242 direction of the interconnect 212. For non-limiting example, the particular edge may be the right edge 252 of the interconnect 212 which is located in the east 242 direction.

The switch 216 may be further configured to reduce congestion in the interconnect 212 by employing the mixed-dimension order routing method 206. The congestion may be reduced relative to the switch 216 employing a different routing method that employs the horizontal-to-vertical dimension routing, exclusively, or the vertical-to-horizontal routing, exclusively. Such congestion is disclosed further below with regard to FIGS. 5A and 5B.

Continuing with reference to FIG. 2A and 2E, the interconnect 212 may include a top row 247, bottom row 249, and a plurality of columns (251a, 251b, 251c). The switch 216 may be further configured to reduce the congestion in the top row 247, the bottom row 249, a column of the plurality of columns (251a, 251b, 251c), or a combination thereof. The congestion in the top row 247, bottom row 249, or column may be due to traffic (not shown) received from a respective edge device, coupled to the top row 247, bottom row 249, or column. The respective edge device may be external to the interconnect 212, such as the top edge device 232, right edge device 234, and bottom edge device 236.

The positive y-coordinates may decrease in a north direction 238. The positive x-coordinates may increase in an east direction 242. By employing the mixed-dimension order routing method 206, the switch 216 may be further configured to prohibit the flit 218 from traversing the interconnect 212 in the east direction 242 and turning to traverse the interconnect 212 in the north direction 238.

As disclosed above, the top row 247 of the interconnect 212 may be associated with the north 238 direction. The mixed-dimension order routing method 206 may include an exception. Based on the exception, the switch 216 may be further configured to enable the flit 218, traversing the interconnect 212 in the east 242 direction, to turn to traverse the interconnect 212 in the north 238 direction in an event the flit 218 is heading in the east direction 242 along the top row 247 and turning in the north 238 direction to a traffic (flit) sink.

The positive y-coordinates may increase in the south 240 direction. By employing the mixed-dimension order routing method 206, the switch 216 may be further configured to prohibit the flit 218 from traversing the interconnect 212 in the east 242 direction and turning to traverse the interconnect 212 in the south 240 direction.

As disclosed above, the bottom row 249 of the interconnect 212 may be associated with the south 240 direction. The mixed-dimension order routing method 206 may include an exception and, based on the exception, the switch 216 may be further configured to enable the flit 218, traversing the interconnect 212 in the east 242 direction, to turn to traverse the interconnect 212 in the south 240 direction in an event the flit 218 is heading in the east 242 direction along the bottom row 249 and turning in the south 240 direction to a traffic sink. The mixed-dimension order routing method 206 may include prohibiting, at most, a first turn type and a second turn type, such as disclosed below with regard to FIG. 2F.

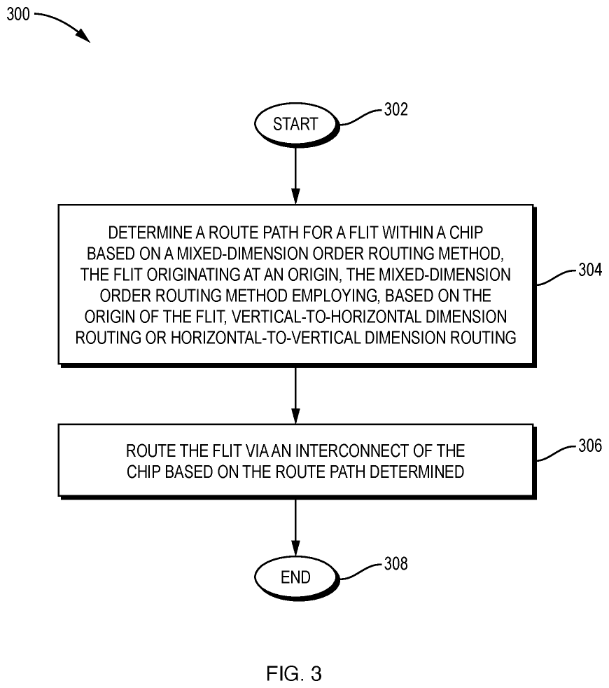

FIG. 2F is a block diagram 260 of an example embodiment of restricted turn types. The block diagram 260 includes a plurality of counter-clockwise turn types 262, namely the counter-clockwise turn types 262-1, 262-2, 262-3, and 262-4, and a plurality of clockwise turn types 264, namely the clockwise turn types 264-1, 264-2, 264-3, and 264-4. With reference to FIG. 2A and FIG. 2F, the mixed-dimension order routing method 206 may include prohibiting, at most, a first turn type and a second turn type. The first turn type and second turn type may be from the plurality of clockwise turn types 262 and the plurality of counter-clockwise turn types 264, respectively. According to an example embodiment, routing in which the flit 218 is heading east 242 and then turns north 238 or south 240 is prohibited, as shown via the crossed-out counter-clockwise turn type 262-3 and crossed-out clockwise turn type 264-1. An example embodiment of a mixed-dimension order routing method that may prohibit same is disclosed below with regard to FIG. 3.

FIG. 3 is a flow diagram 300 of an example embodiment of a method that employs mixed-dimension order routing. The method begins (302) and comprises determining a route path for a flit within a chip based on a mixed-dimension order routing method (304). The flit originates at an origin. The mixed-dimension order routing method employs, based on the origin of the flit, vertical-to-horizontal dimension routing or horizontal-to-vertical dimension routing. The method further comprises routing the flit via an interconnect of the chip based on the route path determined (306). The interconnect is associated with a two-dimensional (2D) coordinate system. The vertical-to-horizontal dimension routing and horizontal-to-vertical dimension routing are relative to the 2D coordinate system. The method thereafter ends (308) in the example embodiment.

FIG. 4A is a flow diagram 400 of another example embodiment of a method that employs mixed-dimension order routing.

FIG. 4B is a continuation of the flow diagram 400 of FIG. 4A. With reference to FIGS. 4A and 4B, the method begins (402) and checks (404) an origin of a flit to determine whether the flit originated from an edge device, such as an input/output bridge (JOB) for non-limiting example, located in the right edge of an interconnect (mesh) of a chip. If the flit originated from such a device, the method checks (405) whether the flit is at a destination node (tile) coupled to the interconnect. If yes, the method routes (407) the flit to the target device at the destination node, sinks (409) the flit, and the method thereafter ends (410) in the example embodiment.

If, however, the check (405) determines that the flit is not at the destination node, the method proceeds to employ horizontal-to-vertical dimension routing and checks (406) for whether the flit is at a node in a destination column of the interconnect. If yes, the method routes (408) the flit vertically to the destination row and the method thereafter ends (410) in the example embodiment. If no, the method checks (412) for whether the flit is at a node in the rightmost column of the interconnect and the destination is at the right edge of the interconnect.

If the flit is at a node in the rightmost column of the interconnect and the destination is at the right edge of the interconnect, the method checks (416) for whether the flit is at a node in the destination row. If yes, the method routes the flit east to the destination column and the method thereafter ends (410) in the example embodiment. If, however, the flit is not at a node in the destination row, the method routes (408) the flit vertically to the destination row and the method thereafter ends (410) in the example embodiment. If, however, the check (412) is negative, the method routes the flit west to a node in the destination column and the method thereafter ends (410) in the example embodiment.

If the check (404) determines that the flit did not originate from an edge device located in the right edge of the interconnect, the method checks (419) for whether the flit is at the destination node. If yes, the method routes (407) the flit to the target device at the destination node, sinks (409) the flit, and the method thereafter ends (410) in the example embodiment. If, however, the check (419) determines that the flit is not at the destination node, the method proceeds to employ vertical-to-horizontal routing and checks (420) for whether the flit is at a node in the destination row. If yes, the method routes (422) the flit horizontally to a node in the destination column and the method thereafter ends (410) in the example embodiment.

If, however, the check (420) determines that the flit is not at a node in the destination row, the method checks (424) for whether the flit is at a node of the top row of the interconnect and the destination in the top edge of the interconnect. If yes, the method checks (426) for whether the flit is at a node in the destination column and, if so, routes (430) the flit north to the destination row and the method thereafter ends (410) in the example embodiment. If, however, the check at (426) determines that the flit is not at a node in the destination column, the method routes (428) the flit horizontally to the destination column and the method thereafter ends (410) in the example embodiment.

If the check (424) is negative, the method checks (432) for whether the flit is at a node at the bottom row of the interconnect and the destination in the bottom edge of the interconnect. If not, the method routes (434) the flit vertically to the destination row and the method thereafter ends (410) in the example embodiment. If, however, the check (432) is positive, the method checks (436) for whether the flit is at a node in the destination column. If yes, the method routes (438) the flit south to the destination row and the method thereafter ends (410) in the example embodiment.

If, however, the check (436) determines that the flit is not at a node in the destination column, the method routes (428) the flit horizontally to a node in the destination column and the method thereafter ends (410) in the example embodiment.

An advantage of the routing methods of FIG. 3 and FIGS. 4A-B, disclosed above, is that such methods prevent deadlock by construction and, simultaneously, reduce interconnect (mesh) congestion by allowing flits to be routed in a manner more suitable to the traffic patterns of their sources. An example embodiment of mixed-dimension order routing disclosed herein accomplishes this without the logical complexity, area, and power overhead of other mitigation techniques, such as a real-time deadlock identification system or virtual channels.

According to an example embodiment traffic (flits) originating from edge devices, such as IOBs for non-limiting example, may be routed horizontally first and then vertically, preventing congestion in a rightmost column of the interconnect by eliminating the need for flits to be routed along that column first before then being routed to their destination. FIG. 5A, disclosed below, includes an exemplification of such congestion.

FIG. 5A is a schematic diagram of an example embodiment of a layout 528 of a circuit with an exemplification of congestion 503 in a rightmost column of an interconnect 512 of the circuit. It should be understood that the layout 528 is for non-limiting example. The interconnect 512 includes a plurality of switches, each referenced as an SW, which connect to a neighboring SW via a routing channel (RC) of the interconnect 512. No edge device is present in the west 544 direction. In the north 538 direction, a top edge device 532 includes a plurality of double data rate 5 (DDRS) physical layer (PHY) devices and a plurality of dynamic memory controllers (DMCs) (not shown) for non-limiting example. The top edge device 532 is coupled to the interconnect 512 via a RC (not shown) of the interconnect and serves as a source/sink for traffic.

In the east 542 direction, a right edge device 534 includes a plurality of peripheral component interconnect express (PCIe) controllers coupled to the interconnect 512 via a RC (not shown) of the interconnect that is coupled to the plurality of PCIe controllers for sourcing and sinking traffic. In the south 540 direction, a bottom edge device 536 includes a plurality of DDRS PHY devices and a plurality of DMCs (not shown) for non-limiting example. The bottom edge device 536 is coupled to the interconnect 512 via a RC (not shown)of the interconnect.

Traffic coming from the memory controllers, such as the DMCs of the top edge device 532 or bottom edge device 536 may be sent to the various TADs throughout the interconnect 512 (mesh). Such TADs are last-level cache (LLC) slices and are each represented as an LLC in the layout 528. It should be understood that each instance of a TAD includes a RC (not shown). Based on an origin of a flit, an example embodiment of a mixed-dimension order routing method may select routing vertically and then horizontally, that is, in a vertical direction 507 and then a horizontal dimension 505. Such a routing selection eliminates a need for flits to be routed along a top row 547 and bottom row 549 first, before then being sent to the destination TADs, preventing congestion in these areas. FIG. 5B, disclosed below, includes an exemplification of such congestion.

FIG. 5B is a schematic diagram of an example embodiment of the layout 528 of FIG. with congestion (501-1, 501-2) in the top row 547 and bottom row 549 of the interconnect.

FIG. 5C is an exemplification of horizontal-to-vertical routing metrics 582 within the layout 528 of FIGS. 5A-B for non-limiting example. Values for the horizontal-to-vertical routing metrics 582 represent projected link utilization ratios, with 0 being idle and 1.0 being fully utilized. Values over 1.0 would be impossible to achieve and indicate the specified performance scenario is not feasible. The colors are coded such that green is low utilization and red is high utilization. The scenario employed for generating such metrics included the AP cores performing 300 GB/s of reads from the TADs and 300 GB/s of writes to the TADs. The PCIe devices performed 150 GB/s of reads from and 150 GB/s of writes to the TADs. In both cases, 50% of the reads/writes are local hits in the TAD and 50% result in reads/writes to the DDR memory controller. The clock rate employed was 2 GHz, and 32 bytes of data were transferred in each flit.

FIG. 5D is an exemplification of vertical-to-horizontal routing metrics 584 within the layout 528 of FIGS. 5A-B for non-limiting example. Values for the vertical-to-horizontal routing metrics 584 represent link utilization. The scenario employed for generating such metrics was the same scenario as disclosed above with reference to FIG. 5C.

FIG. 5E is an exemplification of mixed-dimension routing metrics 586 within the layout of 528 FIGS. 5A-B for non-limiting example. Values for the mixed-dimension routing metrics 586 represent link utilization. The scenario employed for generating such metrics was the same scenario as in FIG. 5C and FIG. 5D, disclosed above. Continuing with reference to FIG. 5E, as observed from the mixed-dimension routing metrics 586, mixed-dimension order routing outperforms exclusive use of horizontal-to-vertical routing or vertical-to-horizontal routing.

The elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method comprising:
determining a route path for a flit within a chip based on a mixed-dimension order routing method, the flit originating at an origin, the mixed-dimension order routing method employing, based on the origin of the flit, vertical-to-horizontal dimension routing or horizontal-to-vertical dimension routing; and
routing the flit via an interconnect of the chip based on the route path determined, the interconnect associated with a two-dimensional (2D) coordinate system, the vertical-to-horizontal dimension routing and horizontal-to-vertical dimension routing relative to the 2D coordinate system.

2. The method of claim 1, wherein the flit is a portion of a packet or the packet in its entirety.

3. The method of claim 1, wherein the 2D coordinate system includes an x-axis and a y-axis and wherein:
the vertical-to-horizontal dimension routing includes turning from a vertical direction to a horizontal direction; and
the horizontal-to-vertical dimension routing includes turning from the horizontal direction to the vertical direction, the horizontal direction and vertical direction parallel to the x-axis and y-axis, respectively.

4. The method of claim 1, wherein the interconnect forms a 2D mesh structure of a plurality of nodes, wherein a node of the plurality of nodes includes a switch, and wherein the routing includes transmitting, via the switch, the flit to another node of the plurality of nodes.

5. The method of claim 1, wherein the mixed-dimension order routing method includes:
employing the horizontal-to-vertical dimension routing in an event the origin is a device located at an edge of the interconnect of the chip; and
employing the vertical-to-horizontal dimension routing otherwise.

6. The method of claim 5, wherein positive y-coordinates and positive x-coordinates of the 2D coordinate system are associated with rows and columns of the interconnect, respectively, wherein the positive x-coordinates increase in an east direction of the interconnect, wherein the edge is a right edge of the interconnect, and wherein the right edge is located in the east direction.

7. The method of claim 1, further comprising avoiding routing deadlock by employing the mixed-dimension order routing method, the routing deadlock otherwise preventing transmission of the flit via the interconnect.

8. The method of claim 1, further comprising reducing congestion in the interconnect by employing the mixed-dimension order routing method, the congestion reduced relative to employing a different routing method that employs the horizontal-to-vertical dimension routing, exclusively, or the vertical-to-horizontal routing, exclusively.

9. The method of claim 8, wherein the interconnect includes a top row, bottom row, and a plurality of columns, wherein the reducing includes reducing the congestion in the top row, the bottom row, a column of the plurality of columns, or a combination thereof, and wherein the congestion in the top row, bottom row, or column is due to traffic received from a respective edge device coupled to the top row, bottom row, or column, the respective edge device external to the interconnect.

10. The method of claim 1, wherein the mixed-dimension order routing method includes prohibiting, at most, a first turn type and a second turn type, the first turn type and second turn type from a plurality of clockwise turn types and a plurality of counter-clockwise turn types, respectively.

11. The method of claim 1, wherein positive y-coordinates and positive x-coordinates of the 2D coordinate system are associated with rows and columns of the interconnect, respectively, wherein the positive y-coordinates decrease in a north direction, wherein the positive x-coordinates increase in an east direction, and wherein the mixed-dimension order routing method includes:
prohibiting the flit from traversing the interconnect in the east direction and turning to traverse the interconnect in the north direction.

12. The method of claim 11, wherein a top row of the interconnect is associated with the north direction, wherein the prohibiting includes an exception, and wherein the exception enables the flit, traversing the interconnect in the east direction, to turn to traverse the interconnect in the north direction in an event the flit is heading in the east direction along the top row and turning in the north direction to a traffic sink.

13. The method of claim 1, wherein positive y-coordinates and positive x-coordinates of the 2D coordinate system are associated with rows and columns of the interconnect, respectively, wherein the positive y-coordinates increase in a south direction, wherein the positive x-coordinates increase in an east direction, and wherein the mixed-dimension order routing method includes:
prohibiting the flit from traversing the interconnect in the east direction and turning to traverse the interconnect in the south direction.

14. The method of claim 13, wherein a bottom row of the interconnect is associated with the south direction, wherein the prohibiting includes an exception, and wherein the exception enables the flit, traversing the interconnect in the east direction, to turn to traverse the interconnect in the south direction in an event the flit is heading in the east direction along the bottom row and turning in the south direction to a traffic sink.

15. A circuit comprising:
an interconnect associated with a two-dimensional (2D) coordinate system; and
a switch coupled to the interconnect, the switch configured to determine a route path for a flit based on a mixed-dimension order routing method, the flit originating at an origin, the mixed-dimension order routing method employing, based on the origin of the flit, vertical-to-horizontal dimension routing or horizontal-to-vertical dimension routing,
the switch further configured to route the flit via the interconnect of the circuit based on the route path determined, the vertical-to-horizontal dimension routing and horizontal-to-vertical dimension routing relative to the 2D coordinate system.

16. The circuit of claim 15, wherein the flit is a portion of a packet or the packet in its entirety.

17. The circuit of claim 15, wherein the 2D coordinate system includes an x-axis and a y-axis and wherein:
the vertical-to-horizontal dimension routing includes turning from a vertical direction to a horizontal direction; and
the horizontal-to-vertical dimension routing includes turning from the horizontal direction to the vertical direction, the horizontal direction and vertical direction parallel to the x-axis and y-axis, respectively.

18. The circuit of claim 15, wherein the interconnect forms a 2D mesh structure of a plurality of nodes, wherein a node of the plurality of nodes includes the switch, and wherein the switch is further configured to route the flit by transmitting the flit to another node of the plurality of nodes.

19. The circuit of claim 15, wherein, by employing the mixed-dimension order routing method, the switch is further configured to:
employ the horizontal-to-vertical dimension routing in an event the origin is a device located at an edge of the interconnect; and
employ the vertical-to-horizontal dimension routing otherwise.

20. The circuit of claim 19, wherein positive y-coordinates and positive x-coordinates of the 2D coordinate system are associated with rows and columns of the interconnect, respectively, wherein the positive x-coordinates increase in an east direction of the interconnect, wherein the edge is a right edge of the interconnect, and wherein the right edge is located in the east direction.

21. The circuit of claim 15, wherein the switch is further configured to avoid routing deadlock by employing the mixed-dimension order routing method, the routing deadlock otherwise preventing transmission of the flit via the interconnect.

22. The circuit of claim 15, wherein the switch is further configured to reduce congestion in the interconnect by employing the mixed-dimension order routing method, the congestion reduced relative to the switch employing a different routing method that employs the horizontal-to-vertical dimension routing, exclusively, or the vertical-to-horizontal routing, exclusively.

23. The circuit of claim 22, wherein the interconnect includes a top row, bottom row, and a plurality of columns, wherein the switch is further configured to reduce the congestion in the top row, the bottom row, a column of the plurality of columns, or a combination thereof, and wherein the congestion in the top row, bottom row, or column is due to traffic received from a respective edge device coupled to the top row, bottom row, or column, the respective edge device external to the interconnect.

24. The circuit of claim 15, wherein, by employing the mixed-dimension order routing method, the switch is further configured to prohibit, at most, a first turn type and a second turn type, the first turn type and second turn type from a plurality of clockwise turn types and a plurality of counter-clockwise turn types, respectively.

25. The circuit of claim 15, wherein positive y-coordinates and positive x-coordinates of the 2D coordinate system are associated with rows and columns of the interconnect, respectively, wherein the positive y-coordinates decrease in a north direction, wherein the positive x-coordinates increase in an east direction, and wherein, by employing the mixed-dimension order routing method, the switch is further configured to:
prohibit the flit from traversing the interconnect in the east direction and turning to traverse the interconnect in the north direction.

26. The circuit of claim 25, wherein a top row of the interconnect is associated with the north direction, wherein the mixed-dimension order routing method includes an exception and wherein, based on the exception, the switch is further configured to enable the flit, traversing the interconnect in the east direction, to turn to traverse the interconnect in the north direction in an event the flit is heading in the east direction along the top row and turning in the north direction to a traffic sink.

27. The circuit of claim 15, wherein positive y-coordinates and positive x-coordinates of the 2D coordinate system are associated with rows and columns of the interconnect, respectively, wherein the positive y-coordinates increase in a south direction, wherein the positive x-coordinates increase in an east direction, and wherein, by employing the mixed-dimension order routing method, the switch is further configured to:
prohibit the flit from traversing the interconnect in the east direction and turning to traverse the interconnect in the south direction.

28. The circuit of claim 27, wherein a bottom row of the interconnect is associated with the south direction, wherein the mixed-dimension order routing method includes an exception, and wherein, based on the exception, the switch is further configured to enable the flit, traversing the interconnect in the east direction, to turn to traverse the interconnect in the south direction in an event the flit is heading in the east direction along the bottom row and turning in the south direction to a traffic sink.

29. The circuit of claim 15, wherein the circuit is an integrated circuit.

30. An apparatus comprising:
means for determining a route path for a flit within a chip based on a mixed- dimension order routing method, the flit originating at an origin, the mixed-dimension order routing method employing, based on the origin of the flit, vertical-to-horizontal dimension routing or horizontal-to-vertical dimension routing; and
means for routing the flit via an interconnect of the chip based on the route path determined, the interconnect associated with a two-dimensional (2D) coordinate system, the vertical-to-horizontal dimension routing and horizontal-to-vertical dimension routing relative to the 2D coordinate system.
